(19) United States
(12) Patent Application Publication
(10) Pub. No.: US 2012/0247696 A1
(43) Pub. Date: Oct. 4, 2012

(54) PULPING PROCESS

(75) Inventors: Johannes Bogren, Goteborg (SE); Tobias Kohnke, Goteborg (SE)

(73) Assignee: SODRA CELL AB, Varobacka (SE)

(21) Appl. No.: 13/462,092

(22) Filed: May 2, 2012

Related U.S. Application Data
(63) Continuation of application No. PCT/EP2009/067165, filed on Dec. 15, 2009.

(51) Int. Cl. D21C 3/00; C12S 3/08

(52) U.S. Cl. 162/99; 162/1; 435/278

(57) ABSTRACT

The present invention relates to a process for forming a pulp mixture, the process comprising the steps of: a) providing a wood material and a first liquor, b) treating the wood material in the first liquor in order to release wood fibers, c1) introducing an agricultural crop/residue before or during the treatment of the wood material, and during the treatment deriving a first fraction comprising hemicellulose from the agricultural crop/residue, and/or c2) introducing a suspension of a first fraction comprising hemicellulose and a residue liquor derived from agricultural crop/residue by a liquor treatment, the introduction being done before, during or after the treatment of the wood material. The invention further relates to a pulp mixture comprising 1-30% originating from agricultural crop/residue and 70-99% originating from wood material. The pulp mixture comprises non-wood hemicellulose and at least part of the non-wood hemicellulose is sorbed on the wood fibers.

### TECHNICAL FIELD

The present invention relates to a process for forming a pulp mixture. The invention further relates to a pulp mixture comprising 1-30% of agricultural crop/residue and 70-99% of wood material.

### BACKGROUND OF THE INVENTION

For many paper producers it is desirable to attain a paper with high tensile index in relation to its basis weight, i.e. tensile index. The ability of providing a high tensile index is therefore an important aspect when choosing a suitable pulp.

Document WO 2008/076215 A1 discloses a process of treating a lignocellulosic material, such as wood. The process includes a pre-extraction step, in which hemicellulose is extracted from the lignocellulosic material. The process also includes a pulping step after the pre-extraction step, in which the lignocellulosic material is separated into pulp. The process further includes an adsorption step, after the pulping step, in which hemicellulose is adsorbed on the pulp. It is further disclosed that the adsorption of the hemicellulose on the pulp increases the pulp yield. The adsorbed hemicellulose was derived from the lignocellulosic material.

Wood used for conventional pulping comprises hemicellulose. Another potential raw material source comprising hemicellulose is agricultural crops. In some cases, part of the agricultural crops may be used for food or animal food and the rest may be used as a hemicellulose source.

In the article “The effect of barley husk arabinoxylan adsorption on the properties of cellulose fibres” by Köhnke et al., Cellulose (2008) 15:537-546, the adsorption of (glucurono)arabinoxylan, GAX, on cellulose fibres was studied. The GAX was isolated using chlorite delignification, alkaline extraction, enzymatic purification followed by precipitation and filtration. The pre-isolated GAX was adsorbed on bleached kraft pulp fibres, which resulted in an evident increase in tensile strength as compared to a reference without GAX. The article covers experiments in laboratory-scale and the residue material, comprising for example fibre material, which remained after having isolated the GAX, was not further investigated in the article.

Köhnke et al. discloses in the above-mentioned article that the GAX was pre-isolated. However, if working in an industrial scale it is desirable to have as few process steps as possible. There is therefore a need for an alternative method for using hemicellulose from an agricultural crop/residue in order to form a pulp mixture in an industrial scale. It is desired that such a method comprises as few process steps as possible.

### SUMMARY OF THE INVENTION

The object of the present invention is to overcome or ameliorate at least one of the disadvantages of the prior art, or to provide a useful alternative.

It is desirable to provide a process using an agricultural crop/residue as a hemicellulose source.

It is further desirable to provide a process which is applicable in industrial scale.

The object above may be achieved by the invention according to claim 1.

In a first aspect of the present invention, there is provided a process for forming a pulp mixture, the process comprising the steps of:

a) providing a wood material and a first liquor,
b) treating the wood material in the first liquor in order to release wood fibres,
c1) introducing an agricultural crop/residue before or during the treatment of the wood material, and during the treatment deriving a first fraction comprising hemicellulose from the agricultural crop/residue,
and/or
c2) introducing a mixture of a first fraction comprising hemicellulose and a residue liquor derived from agricultural crop/residue by a liquor treatment, the introduction being done before, during or after the treatment of the wood material.

The wood material may be provided in the form of timber logs, wood chips and/or sawdust. The wood material may be softwood or hardwood or any mixture thereof.

The first liquor may be the cooking liquor of a chemical pulping process, such as a sulphate, sulphite or soda process. In a preferred embodiment of the invention, a wood pulping process constitutes the treating of the wood in order to release wood fibres. The pulping process may be continuous or batchwise. A typical sulphate pulping process may be done at 5-12 bar, 140-180° C. NaOH cont 5-80 g/l, cooking liquor sulphidity 20-40% and cooking for 40-400 minutes to achieve the desired kappa number.

The first liquor may alternatively be the pre-treating liquid used in a chemithermo-mechanical pulping process, a CTMP process. Examples of pre-treating liquids are sodium carbonate, sodium hydroxide or sodium sulphite. In CTMP processes wood chips are pre-treated with the liquor prior to refining with equipment similar to a mechanical mill. The conditions of the chemical treatment are much less vigorous, for example lower temperature, shorter time, less extreme pH, than in a chemical pulping process since the objective is to make the fibres easier to refine, not to remove lignin as in a chemical pulping process.

The term “non-wood fibre material” is herein used to denote the fibre material originating from the agricultural crop/residue, wherein “fibre material” comprises both fibres and fines, if any fines are present. The term “non-wood hemicellulose” is herein used to denote the hemicellulose originating from the agricultural crop/residue. The “wood fibres” originate from the wood material. “Wood fibres” also comprises fines from wood material.

According to step c1) the wood material and the agricultural crop/residue are treated together in the same liquor. If the agricultural crop/residue also comprises non-wood fibre material, such as fibres and fines, these will then also be present during the treatment. The resulting pulp mixture would in that case, besides the wood fibres and hemicellulose, also comprise non-wood fibre material. Following step c1) makes it possible to use the same processing equipment and the same liquor for the whole process.

Step c2) discloses that the first fraction has been derived from the agricultural crop/residue in a pre-treatment prior to being combined with the wood material. The first fraction is then introduced to the wood material together with the residue liquor resulting from the pre-treatment of the agricultural crop/residue as a mixture. The mixture may be a solution or a suspension. If the first fraction is introduced before or during the treatment of the wood material, they are also, at least partly, treated together. The pre-treatment of the agricultural crop/residue may be done at low temp and low pressure, which is less demanding for the process equipment than for example a chemical pulping process, thereby enabling the use of less complex and cheaper equipment. It is for example possible to use non-pressurized vessels.

Step c1) and c2) have an important feature in common: the first fraction is not separated from the liquor, in which it has been derived from the agricultural crop/residue; instead the first fraction is transferred further in the process together with this liquor. If following step c1), this liquor is the liquor in which the wood material was treated, e.g. the cooking liquor if it is a chemical pulping process. If following step c2), this liquor is the liquor used for the pre-treatment. By passing the first fraction on in the process together with the liquid, unnecessary intermediate steps may be eliminated. The process according to the present invention is thus suitable for an industrial-scale process.

According to an embodiment, one part of the agricultural crop/residue can be introduced according to c1) and one part of it according to c2). This could be advantageous in a pulp plant having quantity bottlenecks for one of the two alternatives c1) or c2).

In step c2) also a second fraction may be derived from the agricultural crop/residue, the second fraction comprising non-wood fibre material, such as fibres and fines, from the agricultural crop/residue. The second fraction will normally be in the form of a suspension. If only the first fraction is used, it may be a solution. The first and the second fractions may be introduced to the wood material at the same time or at different times. The introduction could be made before, during or after the treatment of the wood material, which was described in step b).

If the second fraction is not used further in the process according to the invention for forming a pulp mixture, the second fraction may instead be used in another separate process, such as a pulping process, or be burnt for energy recovery.

When using an agricultural crop/residue comprising hemicellulose as a raw material and isolating the hemicellulose content, there will be residue material comprising for example fibre material to take care of after the hemicellulose isolation. When working in an industrial scale, it is desirable to be able to use the residue material in an efficient way, which way is economical and does not cause waste problems. However, the present invention suggests a way to solve this. As mentioned above, following process step c1) results in a pulp mix comprising the non-wood fibre material. Step c2) including the derivation of the second fraction and introducing it to the wood material also results in that the non-wood fibre material is comprised in the resulting pulp mix. Both these alternatives thus offer a possibility to make use of the non-wood fibre material in an efficient way.

In an embodiment using step c2), the introduction of the first and/or second fractions to the wood material is made at a temperature between 60° C. and 100° C., preferably between 70° C. and 90° C. These temperatures ranges have been found to be beneficial for the properties of the pulp mixture, such as for tensile index. These temperature ranges especially relate to embodiments, wherein the first fraction and/or second fractions are added to the wood material after the treatment of the wood material. If instead the first fraction and/or second fractions are added during the treatment of the wood material, the temperature is preferably a temperature normally used for the treatment of the wood fibres, for example 140-180° C. as used in a chemical pulping process.

In an embodiment using step c2), the derivation of the first fraction and/or second fractions from the agricultural crop/residue is performed at a temperature between 20° C. and 180° C., preferably between 40° C. and 140° C. and most preferably between 50° C. and 90° C. The range 50° C.-90° C. is sometimes advantageous, since non-pressurized vessels may be used.

Further, step c2) is preferably made in an aqueous solution.

In an embodiment using step c2), the derivation of the first fraction and/or second fractions from the agricultural crop/residue is performed at a pH of at least 7, preferably at least 9 and most preferably at least 11.

The above-mentioned process may further comprise the step of:

d) drying the pulp mixture attained in step c1) and/or c2).

The process steps a), b) and c1)/c2) are in that case carried out before step d).

The properties, e.g. tensile index, of the pulp mixture made with the process of the invention are improved as compared to a reference comprising only wood fibres dried in the same way. Normally, a drying stop results in a loss of tensile strength of a pulp, as compared to a never-dried version of the same pulp, but, by using the process according to the invention, this strength loss is reduced. The drying step may be performed in a pulp-drying machine. Such pulp-drying machines are commonly use in pulp mills producing market pulp. Using step d) thus means that the pulp has been dried at least once before reaching the paper machine.

The above-mentioned process may also be used in an integrated mill, either with or without the drying step d). A pulp mixture made with the process of the invention would in that case have improved tensile properties as compared to a reference comprising only wood fibres also if they are compared as never-dried pulp mixtures.

The agricultural crop/residue may originate from an annual plant. Such annual plants may belong to the botanical family Poaceae comprising so called true grasses. This family includes the staple food grains and cereal crops grown all over the world. Examples of suitable agricultural crops/residues are at least one of the following: wheat husk, wheat bran, rye husk, rye bran, oat husk, oat bran, barley husk, barley bran, rice husk, rice bran, corn cobs, corn bran, straw and/or brewer's spent grain. Another suitable plant family is Cannabaceae, for example hemp. A further suitable plant family is Agavaceae, for example agave.

In a preferred embodiment, the hemicellulose of the agricultural crop/residue comprises xylan. “Xylan” is used herein as a generic term to describe a polysaccharide constituting primarily of xylose units in the backbone, and which may to a various degree, but not necessarily, include side groups or chains of monomer units exemplified by arabinose and uronic acids. Examples of uronic acids are glucuronic acid and 4-O-Methyl glucuronic acid. The above-mentioned suitable agricultural crops/residues may comprise xylan.

In a preferred embodiment, at least part of the hemicellulose from the agricultural crop/residue is sorbed on the wood fibres during at least part of the process. The terms “sorb” or “sorption” as used herein comprises absorption and/or adsorption. The terms “sorb” or “sorption” also includes that the hemicellulose may precipitate and deposit on the wood fibres. If non-wood fibres are present, hemicellulose may also be sorbed on these.

If the agricultural crop/residue comprises starch, the process may further comprise a step of reducing a possible starch content of the agricultural crop/residue, for example by enzymatic decomposition. The starch content and/or the components resulting from starch decomposition may be taken out of the process and may be used a source for other processes or may be burnt for energy recovery.

In a second aspect of the present invention, there is provided a pulp mixture comprising:
1-30% originating from agricultural crop/residue, comprising hemicellulose and non-wood fibre material,
70-99% originating from wood material, comprising wood fibres,
   with percentages counted as weight percentage of dry weight,
   wherein the pulp mixture comprises non-wood hemicellulose and at least part of the non-wood hemicellulose is sorbed on the wood fibres.

Preferably 5-25%, and most preferably 10-20% of the pulp mixture originates from the agricultural crop/residue.

Typically the percentage of the non-wood fibre material is at least 1%, preferably at least 5% and most preferably at least 10%, given as weight percentage of total dry weight.

Typically the amount of non-wood hemicellulose sorbed on the wood fibres is at least 1%, preferably at least 2% and most preferably at least 3%, given as weight percentage of total dry weight.

Preferably the hemicellulose comprises xylan.

“Once-dried pulp” refers to that the characterization of the pulp mixture was performed including a step of drying pulp sheets according to a method, which simulates drying in an industrial pulp-drying machine. The used test methods for bleaching, pH-adjustment, drying pulp sheets, beating, making lab sheets and tensile testing are described below in the section TEST METHODS. The given tensile index values herein refer to “once-dried pulp”.

The pulp mixture may exhibit an improved tensile index when tested as lab sheets made of once-dried pulp, the tensile index being at least 2 kNm/kg, preferably at least 4 kNm/kg and most preferably at least 6 kNm/kg higher as compared to a reference sample comprising the wood fibres only, being beaten to the same degree.

Being beaten to the same degree, means that both the pulp mixture and the reference sample, comprising wood fibres only, where exerted to the same beating energy. Typically, the beating energy is varied up to 9000 PH revolutions.

The pulp mixture may exhibit an improved tensile index, when tested as lab sheets made of once-dried pulp, the tensile index being at least 2%, preferably at least 3% and most preferably at least 4% higher as compared to a reference sample comprising the wood fibres only being beaten to the same degree, which beating degree is so high that further beating will not substantially increase the tensile index. Typically, not substantially increased” refers to that the increase of tensile index is less than 10%, in some cases even less than 5%. Purely as an example, a beating degree, which is so high that further beating will not substantially increase the tensile index, may be from 4000 PFI revolutions and upwards.

The pulp mixture may exhibit an improved tensile index, when tested as lab sheets made of once-dried pulp, the tensile index being at least 2 kNm/kg, preferably at least 4 kNm/kg and most preferably at least 6 kNm/kg higher as compared to a reference sample comprising the wood fibres only, being beaten to the same degree for substantially the whole beating curve.

The term “beating curve” denotes a diagram illustrating the tensile index as a function of beating energy. Typically, the beating energy of the beating curve is varied from 0 to 9000 PFI revolutions. For the purpose of the invention “the whole beating curve” refers to a beating curve between 0 and 9000 PFI revolutions.

In a third aspect of the present invention, there is provided a market pulp made by drying an above-mentioned pulp mixture. The market pulp may in a form suitable for sale, for example as pulp sheets, pulp bales, flash-dried pulp or on a roll.

The pulp mixture may be used for e.g. graphical paper, tissue paper, journal paper, newsprint, fine paper, photo paper, MG paper, specialty paper, kraft liner, carton board or nonwoven.

### BRIEF DESCRIPTION OF THE DRAWINGS

The present invention will hereinafter be further explained by means of non-limiting examples with reference to the appended figures wherein:

FIG. 1 shows a process for forming a pulp mixture according to a first embodiment of the first aspect of the invention;

FIG. 2 shows a process for forming a pulp mixture according to a second embodiment;

FIG. 3 shows a process for forming a pulp mixture according to a third embodiment;

FIG. 4 shows a process for forming a pulp mixture according to a fourth embodiment;

FIG. 5 shows a process for forming a pulp mixture according to a fifth embodiment;

FIG. 6 shows a process for forming a pulp mixture according to a sixth embodiment;

FIG. 7 shows tensile index as a function of beating for Trial 1;

FIG. 8 shows tensile index as a function of beating for Trial 2;

FIG. 9 shows tensile index as a function of beating for Trial 3;

FIG. 10 shows tensile index as a function of sheet density for Trial 3;

### DETAILED DESCRIPTION OF PREFERRED EMBODIMENTS

The invention will, in the following, be exemplified by embodiments. It should however be realized that the embodiments are included in order to explain principles of the invention and not to limit the scope of the invention, defined by the appended claims. Details from two or more of the embodiments may be combined with each other.

In general terms the process according to the invention comprises the steps of:

a) providing a wood material and a first liquor,
b) treating the wood material in the first liquor in order to release wood fibres,
c1) introducing an agricultural crop/residue before or during the treatment of the wood material, and during the treatment deriving a first fraction comprising hemicellulose from the agricultural crop/residue,
and/or
c2) introducing a mixture of a first fraction comprising hemicellulose and a residue liquor derived from agricultural crop/residue by a liquor treatment, the introduction being done before, during or after the treatment of the wood material.

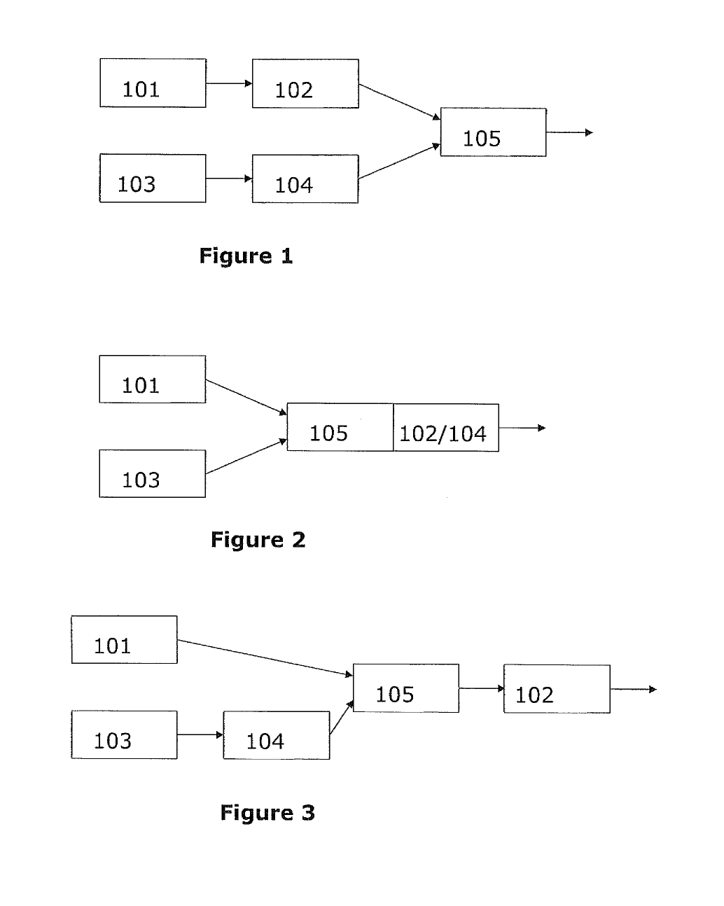

Below, a number of embodiments are presented by means of schematic block diagrams in FIGS. 1-6. Each box represents a process step. Below they are presented in the same order as in FIG. 1. However, their internal order may be varied in many ways, as will be further described below with reference to FIGS. 2 to 6.

FIG. 1 is a schematic block diagram of a process according to a first embodiment of the invention.

In step 101a wood material is provided, e.g. in the form of timber logs, wood chips and/or sawdust. The wood material may be softwood or hardwood or any mixture thereof.

In step 102 the wood material is treated in a first liquor in order to release wood fibres. Preferably, step 102 is a commonly used industrial pulping process, such as a sulphate, sulphite, soda or CTMP pulping process. Such pulping processes, including their process chemicals and process conditions, are well known to the person skilled in the art, and will not be described in any detail in this patent application.

In step 103 an agricultural crop/residue is provided, which comprises hemicellulose and possibly fibre material. Examples of suitable agricultural crops/residues are wheat husk, rye husk, oat husk, barley husk, rice husk, corn cobs, straw, brewer's spent grain, hemp and/or agave, or mixtures thereof.

In step 104 the agricultural crop/residue is treated in order to derive at least a first fraction comprising hemicellulose. Optionally, also a second fraction comprising non-wood fibre material is derived. The fibre material may include both fibres and fines, if any fines are present. The treatment is performed without any drying or additional intermediate step of isolating the hemicellulose. It is further to be noted, that the first and the optional second fraction are transferred further in the process together with the liquor, in which the agricultural crop/residue was treated.

In step 105 the agricultural crop/residue or the first and/or the optional second fractions derived from the agricultural crop/residue is/are introduced to the wood material. The resulting pulp mixture comprises wood fibres from the wood material, as well as non-wood hemicellulose from the first fraction and optionally non-wood fibre material from the second fraction of the agricultural crop/residue.

In the process according to the first embodiment, which is shown in FIG. 1, the wood material and the agricultural crop/residue are treated in two different process steps, 102 and 104, i.e. a variant of c2) described above. Thereby process chemicals and process conditions can be adapted to the respective task of releasing wood fibres and deriving at least the first fraction. Therefore, step 104 may be done at low temp and low pressure, which is less demanding for the process equipment, thereby enabling the use of less complicated and cheaper equipment. It is for example possible to use non-pressurized vessels. The first and the optional second fraction are transferred further in the process together with the liquor, in which the agricultural crop/residue was treated.

FIG. 2 illustrates a second embodiment of the invention, wherein the wood material and agricultural crop/residue are treated together, i.e. a variant of c1) described above. Thereby steps 102 and 104 can use the same processing equipment and the same liquor.

In FIG. 3, a third embodiment is illustrated, wherein the first fraction and optionally the second fraction is derived from the agricultural crop/residue before being added to the wood material, and the resulting mixture is thereafter treated to release the wood fibres, i.e. a variant of c2) described above. The first fraction and the optional second fraction resulting from step 104 are transferred further in the process together with the liquor the agricultural crop/residue was treated in.

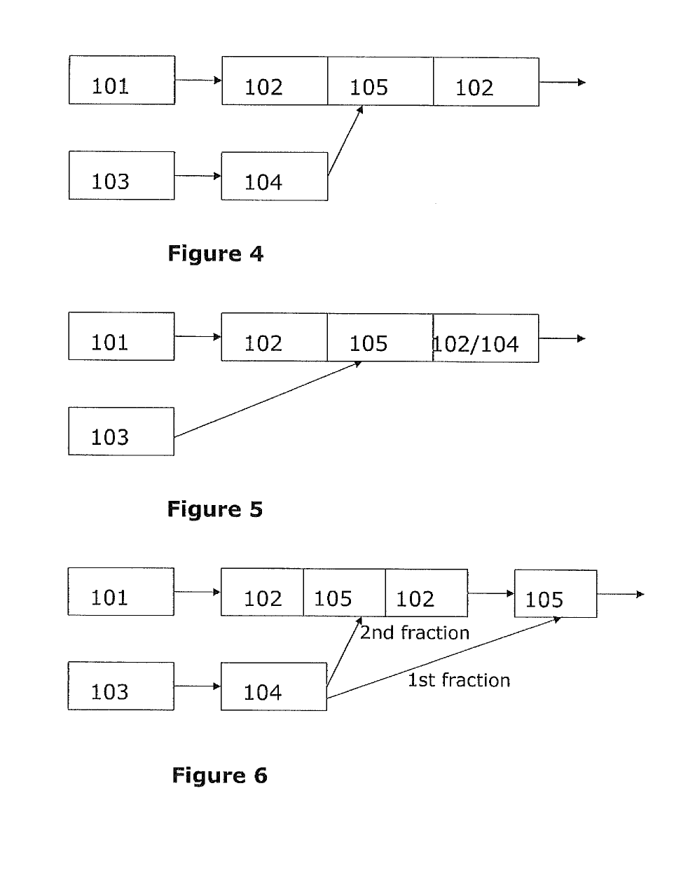

The fourth embodiment, disclosed in FIG. 4, illustrates a generalized variant of c2) described above, wherein the first fraction and the optional second fraction derived from the agricultural crop/residue are added during the treatment of the wood material. The addition may be made at any time, from the very beginning until the very end of the wood treatment, Adding at the very beginning corresponds to FIG. 3, while adding at the very end corresponds to FIG. 1.

In FIG. 5, a fifth embodiment is shown, wherein the agricultural crop/residue is added during the treatment of the wood material i.e. a variant of c1) described above. The agricultural crop/residue may be introduced at any time during the treatment. Adding at the very beginning corresponds to FIG. 2. There should however be enough time during the combined treatment step 102/104, such that the desired derivation of at least the first fraction of the agricultural crop/residue is attained.

FIGS. 1 to 5 show that the first fraction and optional second fraction of the agricultural crop/residue are added to the wood material at the same time. It is however, also possible to add them on different occasions, for example adding the second fraction during the wood treatment as in FIG. 4 and adding the first fraction after the wood treatment as in FIG. 1. See FIG. 6, which is a variant of c2) described above.

The pulp mixture resulting from step 105 of the claimed process may comprise: 1-30% originating from agricultural crop/residue and 70-99% originating from wood material, with percentages counted as weight percent of dry weight.

The pulp mixture comprises non-wood hemicellulose, originating from the above first fraction, and possibly non-wood fibre material, originating from the above second fraction plus wood fibres, originating from the wood material. As a result of the process, at least part of the non-wood hemicellulose is sorbed on the wood fibres.

The percentages of the non-wood fibre material will depend on factors such as the percentage of agricultural crop/residue and the source of agricultural crop/residue, since different sources will have different percentages of fibre material and hemicellulose. Fibre material includes both fibres and fines. The relative fines content will vary depending on for example the source of agricultural crop/residue and the treatment process, step 104 above.

### Test Methods

### Bleaching

The pulp mixtures in the trials below were bleached in order to reach full brightness. The bleaching was performed in lab-scale according to the sequence OO Q OP Q PO.

pH-Adjustment

After bleaching, the pulp was pH-adjusted to pH 5.5-6.0.

### Drying Method for Pulp Sheets

A drying method was used, which simulates the drying made in an industrial pulp-drying machine.
1. Defibrate 10 g air-dried pulp in 2 litres water, 2500 revolutions. (Based on ISO 5263-1:2004 Pulps—laboratory wet disintegration—part one: disintegration of chemical pulps.)
2. Pour into the sheet-former, fill up with water. Let bubbles pass until all large fibre bundles have disappeared.
3. Let the suspension pass. Let air pass.
4. Place a blotting paper on top of the formed lab sheet, until it does not wet through.
5. Couch for 20-30 s.
6. Remove all blotting papers.
7. Put five blotting papers in the sheet stack. Carefully remove the formed pulp sheet from the forming wire, put it on top of the blotting papers and label it if desired.
8. Put five blotting papers on top of the formed pulp sheet in the sheet stack.
9. Press with 0.36 MPa for 7 min.
10. Remove the wet blotting papers and put the formed pulp sheet between two dry blotting papers.
11 Clamp in a drying screen.
12. Let dry for 24 hours.
13. Place the formed pulp sheets in a rack for conditioning until the pulp sheet has stabilized.

### Lab Beating

ISO 5264-2:2002: Pulps—Laboratory beating—Part 2: PFI mill method.

The beating energy of the beating curve was varied from 0 to 9000 PFI revolutions.

### Laboratory Sheets

ISO 5269-1:2005: Pulps—Preparation of laboratory sheets for physical testing—Part 1: Conventional sheet-former method.

### Physical Testing of Lab Sheets

ISO 1924-3:2005: Paper and board—Determination of tensile properties—Part 3: Constant rate of elongation method (100 mm/min).

ISO 534:1988: Paper and board—Determination of thickness and apparent bulk density or apparent sheet density.

### Test Sequence Used in Trials 1-3

Treatment-bleaching-pH-adjustment-drying pulp sheets-refining-lab sheets-physical testing.

### Trials

### Trial 1

The trial followed the first embodiment of the method as described for FIG. 1 above, i.e. the wood material and the agricultural crop/residue were treated in two different processes, steps 102 and 104, and thereafter combined, step 105, i.e. a variant of c2) described above using only the first fraction. In the trial, the agricultural residue was barley husk and the hemicellulose was xylan.

The xylan was extracted by making a “stock solution”. Two extraction series with six autoclaves each comprising 200 g barley husk were used. Husk to liquor ratio was 1 kg husk to 10 litres liquor. The autoclaves were further loaded with liquor corresponding to 30% effective alkali with 30% sulphidity and deionized water. The autoclaves were heated 15 minutes at 70° C., whereafter the temperature was raised by 0.8° C./min up to 140° C. when the autoclaves were taken out. The liquor from all autoclaves was filtered and mixed together to be used as stock solution. The stock solution thus comprised a mixture of hemicellulose and residue liquor, i.e. the first fraction and associated liquor. The solid residue, mainly fibre material, was filtered off and taken care of to be used as the non-wood fibre fraction, i.e. the second fraction, for Trial 2. The stock solution had a xylan concentration of 20.6 g/l and arabinos/xylos ratio of 0.28.

The wood fibres came from the industrial-scale production of a commercial softwood pulp according to the sulphate process.

The stock solution was charged in an autoclave together with the wood fibres. The charges were made to correspond to 3%, 6% and 12% xylan, with percentages given as weight percent of dry weight of the pulp. The alkali concentration was adjusted to 6 grams/litre. Sorption went on for 120 minutes at 90° C.

it could be seen that the yield was improved due to xylan adsorption: +1.6% for “3% xylan”, +3.4% for “6% xylan” and +5.2% for “12% xylan”, i.e. roughly 50% of the charged xylan was sorbed. The amount of xylan increased from 8.6% for the reference to 10.1% for “3% xylan” and 10.7% for “6% xylan”. The xylan content comprised in the reference originates from the wood material.

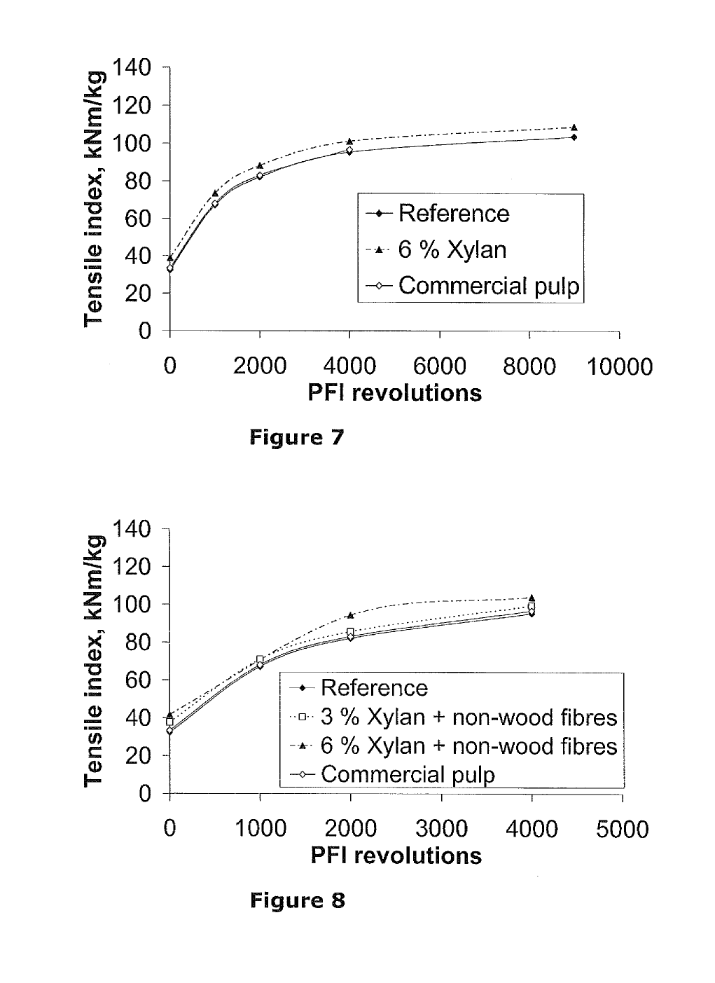

The pulp for the reference sample and the “6% xylan” sample was bleached, pH-adjusted and dried according to the drying method for pulp sheets above. Thereafter it was beaten in a PFI refiner, lab sheets were formed and physical testing was performed. As a comparison, industrially dried pulp of the same raw material was taken out from the industrial-scale pulping process. This sample is denoted “commercial pulp”. See Table 1 and FIG. 7.

TABLE 1
Tensile Index (kNm/kg) Trial 1

| PFI revolutions | 0 | 1000 | 2000 | 4000 | 9000 |
|---|---|---|---|---|---|
| Reference | 32.4 | 67.1 | 82.1 | 95.3 | 104 |
| 6% xylan | 38.9 | 73.5 | 88.2 | 101 | 109 |
| Commercial pulp | 33.5 | 68.0 | 83.1 | 96.7 | |

FIG. 7 illustrates tensile index as a function of number of revolutions in the PFI refiner. The reference sample with 0% xylan coincides pretty well with the commercial pulp, which shows that the drying method described above was suitable for comparison purposes. It is further seen that the “6% xylan” pulp sample has a higher tensile index than the reference sample for the whole beating curve. For unbeaten pulp the difference for tensile index was 6.5 kNm/kg.

### Trial 2

The trial followed the first embodiment of the method as described for FIG. 1 above, i.e. the wood material and the agricultural crop/residue were treated in two different processes, steps 102 and 104, and thereafter combined, step 105, i.e. a variant of c2) described above using both the first and second fractions. In the trial, the agricultural residue was barley husk and the hemicellulose was xylan. The difference from Trial 1 is consequently that both the first and the second fractions were used.

Pulp was charged in an autoclave together with stock solution, already described in connection to Trial 1, to get the desired xylan content. See Table 2 below. The amount of xylan was chosen to 3% and 6%, with percentages given as weight percent of dry weight of the wood fibres plus non-wood fibres. The amount of non-wood fibre material was chosen to reflect the amount of xylan. For 3% xylan”, 6% of the wood fibres were replaced by the non-wood fibre fraction and for “6% xylan”, 12% of the wood fibres were replaced by the non-wood fibre fraction. There was also a reference sample comprising only wood fibres, being the same reference as for Trial 1.

TABLE 2
Charges Trial 2.

| | Reference | 3% xylan | 6% xylan |
|---|---|---|---|
| wood fibres (grams) | 200 | 188 | 176 |
| xylan (grams) | | 6 | 12 |
| non-wood fibres | | 12 | 24 |
| (grams) | | | |

The content of the autoclave was adjusted to attain an alkali concentration of 6 grams/litre by adding an acid. The samples were heated during 10 min and allowed to react for 120 min at 90° C. Thereafter the pulp was washed.

It could be seen that the yield was improved due to xylan adsorption. The amount of xylan increased from 8.6% for the reference to 10.4% for “3% xylan” and 11.7% for “6% xylan”. The xylan in the reference is from the wood material. Comparison with Trial 1, shows that the second fraction contributed in a positive way to increase the xylan amount. Without being bound by theory, it is believed that this may be due to that non-wood fibres comprises more xylan than the used wood fibres or to that the xylan is more easily sorbed on the non-wood fibre material than on the wood fibres.

The pulp was bleached, pH-adjusted and dried according to the drying method for pulp sheets above. Thereafter it was beaten in a PFI refiner and lab sheets were formed and physical testing was performed. See Table 3 and FIG. 8.

TABLE 3
Tensile Index (kNm/kg) Trial 2

| PFI revolutions | 0 | 1000 | 2000 | 4000 | 9000 |
|---|---|---|---|---|---|
| Reference | 32.4 | 67.1 | 82.1 | 95.3 | 104 |
| 3% Xylan + 6% non-wood fibres | 37.7 | 71.0 | 85.7 | 99.4 | |
| 6% Xylan + 12% non-wood fibres | 41.8 | | 94.3 | 104 | |
| Commercial pulp | 33.5 | 68.0 | 83.1 | 96.7 | |

FIG. 8 illustrates tensile index as a function of number of revolutions in the PFI refiner. As a comparison to the three pulp mixtures, industrially dried pulp of the same raw material was taken out from the industrial-scale pulping process, same as for Trial 1. This sample is denoted “commercial pulp”. The pulp samples with added first and second fractions have a higher tensile index than the reference sample for the whole beating curve, with the highest values for “6% xylan”. For unbeaten pulp the tensile index was 32.4 kNm/kg for the reference, 37.7 kNm/kg for “3% xylan” and 41.8 kNm/kg for “6% xylan, i.e. higher than for Trial 1.

### Trial 3

The trial followed the second embodiment of the method as described for FIG. 2 above, i.e. the wood material and the agricultural crop/residue were cooked together as described for c1) above. In the trial, the agricultural residue was barley husk and the hemicellulose was xylan. Note that the reference of Trial 3 is different from the reference of Trials 1 and 2. However “15% agricultural residue” corresponds to the “6% xylan” sample of Trial 2 regarding the amount of xylan and non-wood fibres.

The reference sample for trial 3 was prepared according to:

Wood chips: softwood, dried and screened
Amount of wood chips: 300 g
Wood/liquor ratio: 1:4
Effective alkali charge: 19.5%
Start temperature: 70° C.
Ramping: 0.8° C./min during 120 min
Max temp: 170° C.
Pre-heating time: 15 min
Time at max temp: 125 min.

The trial sample, called “15% agricultural residue”, was prepared according to:

Wood chips: softwood, dried and screened
Amount of wood chips: 255 g
Amount of barley husks: 45 g
(Wood+barley husk)/liquor ratio: 1:4
Effective alkali charge: 20.3%
Start temperature: 70° C.
Ramping: 0.8° C./min during 120 min
Max temp: 170° C.
Pre-heating time: 15 min
Time at max temp: 125 min.

After the cook, the pulp mixture was defibrated and screened. Thereafter the pulp mixture was bleached and pH-adjusted to pH 5.5-6.0. Then the pulp was dried according to the drying method for pulp sheets above. The pulp was thereafter beaten in a PFI refiner. Lab sheets were made in a sheet former. Physical testing was performed.

TABLE 4
Tensile Index (kNm/kg) Trial 3

| PFI revolutions | 0 | 1000 | 2000 | 4000 | 9000 |
|---|---|---|---|---|---|
| Reference | 35.0 | 78.7 | 96.0 | 109 | 113 |
| 15% agricultural | 45.7 | 86.5 | 103 | 116 | 120 |
| residue | | | | | |
| Commercial pulp | 33.5 | 68.0 | 83.1 | 96.7 | |

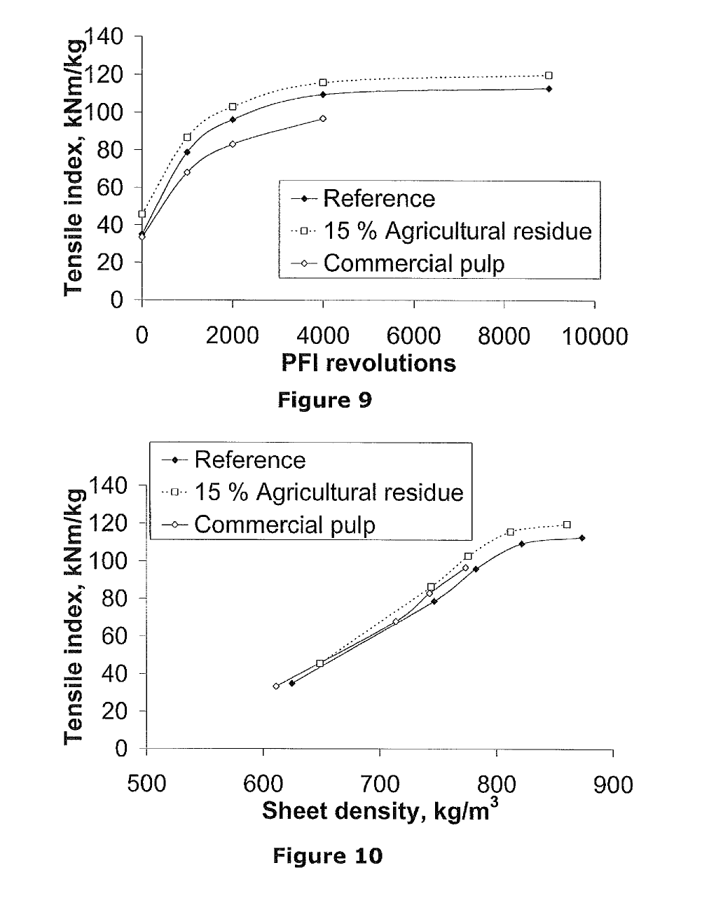

FIG. 9 illustrates tensile index as a function of number of revolutions in the PFI refiner. The effect of the xylan and non-wood fibre fraction is seen for the whole beating curve. The diagram also shows data for the commercial pulp, the same as for FIGS. 7 and 8. For unbeaten pulp, the reference and commercial pulp have similar values, but with beating, the commercial pulp is lower than the reference. It is however a well known effect that pulp cooked in the lab is stronger than cooked in an industrial pulping process. For unbeaten pulp, the “15% agricultural residue” sample is about 30% stronger than the reference. The “15% agricultural residue” sample is further clearly over the reference for the whole beating curve.

FIG. 10 shows tensile index as a function of sheet density. As can be seen the tensile index is higher for the “15% agricultural residue” sample than the reference, when compared at a given density. This is true for the whole beating curve.

Further modifications of the invention within the scope of the appended claims are feasible. As such, the present invention should not be considered as limited by the embodiments and figures described herein. Rather, the full scope of the invention should be determined by the appended claims, with reference to the description and drawings.

The enclosed trials illustrate bleaching according to the sequence OO Q OP Q PO. However, also other bleaching sequences work, such as OO D EOP Q PO or D1(EO) D D. Moreover, the bleaching step may be also be skipped. The invention also works for unbleached pulp mixtures.

1. A pulping process for forming a pulp mixture, said process pulping comprising the steps of:
a) providing a wood material and a first liquor,
b) treating the wood material in a wood pulping process in said first liquor in order to release wood fibers,
c1) introducing an agricultural crop/residue before or during said treatment of the wood material, and during the treatment deriving a first fraction comprising hemicellulose from said agricultural crop/residue and/or
c2) introducing a mixture of a first fraction comprising hemicellulose and a residue liquor derived from agricultural crop/residue by a liquor treatment, said introduction being done before, during or after said treatment of the wood material.

2. (canceled)

3. The pulping process according to claim 1, said process comprising said steps of a), b), c1) and c2.

4. The pulping process according to claim 1, wherein further a second fraction is derived from said agricultural crop/residue in step c2), said second fraction comprising non-wood fiber material from said agricultural crop/residue, and wherein said first and second fractions are introduced to the wood material at the same time or at different times.

5. The pulping process according to claim 1, wherein the wood pulping process, is a sulphate, sulphite, soda or CTMP process.

6. The pulping process according to claim 1, wherein in step c2), the introduction of the first and/or second fractions is made at a temperature between 60° C. and 100° C., preferably between 70° C. and 90° C.

7. The pulping process according to claim 1, wherein in step c2) said derivation of said first fraction and/or second fractions from said agricultural crop/residue is performed at a temperature between 20° C. and 180° C., preferably between 40° C. and 140° C. and most preferably between 50° C. and 90° C.

8. The pulping process according to claim 1, wherein in step c2) said derivation of said first fraction and/or second fractions from said agricultural crop/residue is performed at a pH of at least 7, preferably at least 9 and most preferably at least 11.

9. The pulping process according to claim 1, wherein the pulping process further comprises the step of; d) drying the pulp mixture attained in step c1) and/or c2).

10. The pulping process according to claim 1, wherein the agricultural crop/residue comprises at least one of the following: wheat husk, rye husk, oat husk, barley husk, rice husk, corn cobs, straw, hemp, agave and/or brewer's spent grain.

11. The pulping process according to claim 1, wherein the hemicellulose of the agricultural crop/residue comprises xylem

12. The pulping process according to claim 1, wherein at least part of the hemicellulose from the agricultural crop/residue is sorbed on the wood fibers during at least part of said process.

13. The pulping process according to claim 1 further comprising a step of reducing a possible starch content of the agricultural crop/residue, for example by enzymatic decomposition.

14. A pulp mixture comprising
1-30% originating from agricultural crop/residue, comprising hemicellulose and non-wood fiber material,
70-99% originating from wood material, comprising wood fibers,
with percentages counted as weight percentage of dry weight, wherein said pulp mixture comprises non-wood hemicellulose and at least pant of said nonwood hemicellulose is sorbed on said wood fibers.

15. The pulp mixture according to claim 14, wherein the percentage of the non-wood fiber material is at least 1%, preferably at feast 5% and most preferably at least 10%, given as weight percentage of total dry weight.

16. The pulp mixture according to claim 14, wherein the amount of non-wood hemicellulose sorbed on the wood fibers is at least 1%, preferably at least 2% and most preferably at least 3%, given as weight percentage of total dry weight.

17. The pulp mixture according to claim 14, wherein said pulp mixture exhibits an improved tensile index when tested as lab sheets made of once-dried pulp, said tensile index being at least 2 kNmlkg, preferably at least 4 kNmlkg and most preferably at least 6 kNmlkg higher as compared to a reference sample comprising the wood fibers only, being beaten to the same degree.

18. The pulp mixture according to claim 14, wherein said pulp mixture exhibits an improved tensile index, when tested as lab sheets made of once-dried pulp, said tensile index being at least 2%, preferably at least 3% and most preferably at least 4% higher as compared to a reference sample comprising the wood fibers only, being beaten to the same degree, which beating degree is so high that further beating will not substantially increase the tensile index.

19. The pulp mixture according to claim 14, wherein said pulp mixture exhibits an improved tensile index when tested as lab sheets made of once-dried pulp, said tensile index being at least 2 kNm/kg, preferably at least 4 kNmlkg and most preferably at least 6 kNmlkg higher as compared to a reference sample comprising the wood fibers only, being beaten to the same degree, for substantially the whole beating curve.

20. A market pulp made by drying a pulp mixture according to claim 14.
